(19) United States
(12) Patent Application Publication
(10) Pub. No.: US 2010/0235556 A1
(43) Pub. Date: Sep. 16, 2010

(54) MULTI-DISPLAY DIGITAL PHOTO FRAME

(75) Inventors: JIA-YONG YE, Shenzhen City (CN); GAO-HUI TANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/422,209

(22) Filed: Apr. 10, 2009

(30) Foreign Application Priority Data
Mar. 13, 2009 (CN) 200920301286.1

(51) Int. Cl. G06F 13/00

(52) U.S. Cl. 710/110

(57) ABSTRACT

A multi-display digital photo frame is provided. The multi-display digital photo frame includes an user input unit, a memory, at least two displays, and an appropriate number of processors, wherein the number of the processors is equal to the number of the displays, each of the processors is connected with a display, and is configured for controlling the corresponding display.

### BACKGROUND

1. Technical Field

The present disclosure relates to a multi-display digital photo frame.

2. Description of Related Art

Digital photo frames are intended to conveniently display images without the need to print the images out. Displaying image is an essential function of digital photo frames, therefore, various manners for displaying images will be an important selling point for attracting customers. However, many digital photo frames have only single LCD, accordingly, forms of displaying images in single LCD is restricted. Therefore, what is needed is a digital photo frame with multi-display which can overcome the aforementioned shortcomings.

### BRIEF DESCRIPTION OF THE DRAWINGS

The components of the drawings are not necessarily drawn to scale, the emphasis instead being placed upon clearly illustrating the principles of a multi-display digital photo frame. Moreover, in the drawings, like reference numerals designate corresponding parts throughout several views.

FIG. 1 is a block diagram of a multi-display digital photo frame in accordance with an exemplary embodiment.

FIG. 2 is a block diagram of a multi-display digital photo frame in accordance with another exemplary embodiment.

FIG. 3 is a multi-display digital photo frame with two LCDs in accordance with an exemplary embodiment.

### DETAILED DESCRIPTION

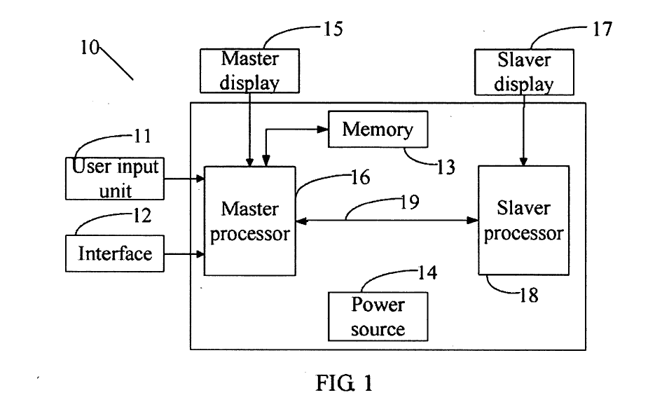

FIG. 1 is a block diagram of a hardware infrastructure of a multi-display digital photo frame 10 in accordance with an exemplary embodiment. The multi-display digital photo frame 10 includes at least one user input unit 11, an interface 12, a memory 13, a power source 14, a bus 19, at least two displays, and an appropriate number of processors. The number of the processors is equal to the number of the displays. For illustrative purpose, hereinafter, two displays and two processors are taken as an example.

Each of the processors is connected to a corresponding display, and is configured for controlling the display. Furthermore, one of the processors is defined as a master processor 16, and the other is defined as a slave processor 18. Accordingly, the display connected with the master processor is defined as a master display 15, and the other display connected with the slave processor is defined as a slave display 17.

The master processor 16 is further connected with the slave processor 18 through the bus 19, for example, a USB bus. The master processor 16 is configured for obtaining images from the memory 13 and displaying the images in the master display 15. The master processor 16 is also configured for generating control signals in response to user input from the user input unit 11, and sending the control signals to the slave processor 18 through the USB bus 19. The slave processor 18 is configured for displaying images in the slave display 17 according to the control signals.

The interface 12, connected with the master processor 16, is configured for the multi-display digital photo frame to communicate with an external device (not shown). The interface 12 can be a SD card port, a USB port, and so on.

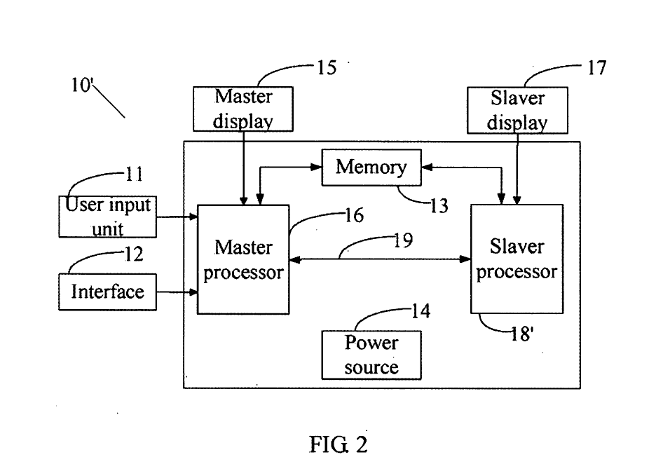

The memory 13 is configured for storing images and other media files. The memory 13 is connected to the master processor 16 (see FIG. 1), and can also be connected to the slave processor 18 (see FIG. 2).

In the first exemplary embodiment as shown in FIG. 1, the slave processor 18 is not connected to the memory 13, accordingly, the slave processor 18 cannot obtain images from the memory 13 directly. In the configuration of FIG. 1, when receiving the user input from the user input unit 11, the master processor 16 obtains image files from the memory 13, and displays the images in the master display 15. At the same time, the master processor 16 generates the control signals for controlling the slave processor 18 to display the images on the slave display 17. The control signals indicate control information related to the to-be-displayed images in the slave display 17. For example, the control information includes, but is not limited to, to-be-displayed images, and predetermined manners of displaying the images, for example, zoom out an image in master display 15 and zoom in another image in the slave display 17 synchronously. The slave processor 18 displays the images in the predetermined manner according to the control signals.

For the purpose of easily understanding the first exemplary embodiment, an exemplary process of displaying images is described as follows. When the multi-display digital photo frame 10 starts to display images in response to the user input, the master processor 16 obtains an image A and an image B from the memory 13, and displays the image A in the master display 15. At the same time, the master processor 16 generates the control signals to the slave processor 18 through the USB bus 19, wherein the control signals indicate the control information, for example, the image B and the manner of displaying the image B. The slaver processor 18 displays the image B according to the manner indicated by the control signals. For example, the slave processor 18 gradually zooms in/out the image B in the slave display 17. In addition, the slave display 17 can have the same display manner as that of the master display 15.

In the second exemplary embodiment as shown in FIG. 2, the memory 13 further connects to the slave processor 18′, as compared with FIG. 1, that is, the memory 13 connects to both the master processor 16 and the slave processor 18′. In the configuration of FIG. 2, when receiving the user input from the user input unit 11, the master processor 16 obtains digital image files from the memory 13, and displays the images in the master display 15. At the same time, the master processor 16 generates the control signals for controlling the slave processor 18′ to display the images on the slave display 17. The control signals also indicate control information related to the to-be-displayed images in the slave display 17. The control information includes, but is not limited to, access addresses of the images, names of the images, and manners of displaying the images. The slave processor 18′ obtains the images from the memory 13 according to the control information (i.e., the names or the access addresses thereof) and displays the obtained images in the predetermined manner according to the control signals.

For the purpose of easily understanding the second exemplary embodiment, another exemplary process of displaying images is described as follows. When the multi-display digital photo frame 10′ starts to display images, the master processor 16 obtains an image A from the memory 13, and displays the image A in the master display 15. At the same time, the master processor 16 generates the control signals to the slave processor 18′ through the USB bus 19, wherein the control signals indicate, for example, the name or access address of image B′ and the predetermined manner of displaying the image B′. The slaver processor 18′ obtains image B′ from the memory 13 according to the control information, for example, the access address of the image B′ in the memory 13, and displays the image B′ in the predetermined manner according to the control signals.

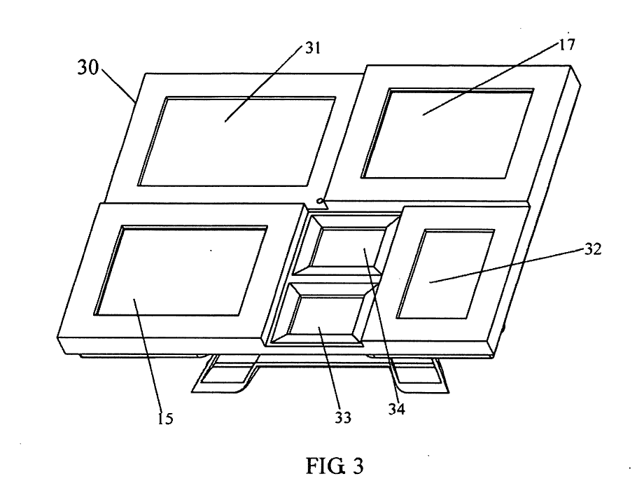

FIG. 3 is an exemplary diagram of an appearance of the multi-display digital photo frame of FIG. 1 or FIG. 2 in accordance with an exemplary embodiment. The multi-display digital photo frame 10 further includes a plurality of display frames 31, 32, 33, and 34. These display frames are configured for displaying paper photos.

Although the present embodiments have been specifically described as examples, the disclosure is not to be construed as being limited thereto. Various changes or modifications may be made to the embodiment without departing from the scope and spirit of the invention.

What is claimed is:

1. A multi-display digital photo frame comprising:
a user input unit;
a memory for storing images;
at least two displays for display images; and
at least two processors, wherein each of the processors is connected with a corresponding display, one of the processors is defined as a master processor, and each of the rest of the at least two processors is defined as a slave processor, the master processor connects with the slave processor through a bus, the display connected with the master processor is defined as a master display, and each of the rest of the at least two displays connected with a slave processor is defined as a slave display;
the master processor is configured for obtaining images from the memory and displaying the images on the master display, and is further configured for generating control signals in response to user inputs from the user input unit and sending the control signals to the slave processors through the bus; and
each slave processor is configured for displaying images on the slave display according to the control signals from the master processor.

2. The multi-display digital photo frame as described in claim 1, further comprising an interface for communicating with an external device, wherein the master processor is connected to the interface.

3. The multi-display digital photo frame as described in claim 1, further comprising at least one display frame for displaying paper photos.

4. The multi-display digital photo frame as described in claim 1, wherein the control signals indicate control information related to to-be-displayed images in the slave display, and the control information comprise the images and a manner of displaying the images in the salve display.

5. The multi-display digital photo frame as described in claim 1, wherein the memory is further connected with the slave processor, the control signals indicate control information related to to-be-displayed images in the slave display, and the control information comprise access addresses or names of the images to-be-displayed in the slave display and a manner of displaying the images in the slave display.

6. The multi-display digital photo frame as described in claim 1, wherein the bus is a USB bus.
